(19) United States
(12) Patent Application Publication
(10) Pub. No.: US 2019/0340352 A1
(43) Pub. Date: Nov. 7, 2019

(54) METHOD FOR PRODUCING DYNAMIC PASSWORD IDENTIFICATION FOR USERS SUCH AS MACHINES

(71) Applicants: Ivan JC Peeters, Beveren (BE); Kris Rottiers, Hofstade (BE)

(72) Inventors: Ivan JC Peeters, Beveren (BE); Kris Rottiers, Hofstade (BE)

(21) Appl. No.: 15/970,731

(22) Filed: May 3, 2018

(51) Int. Cl. G06F 21/45; H04L 29/06; H04L 9/06; G06F 17/30

(52) U.S. Cl. CPC G06F 21/45; H04L 63/083; G06F 17/30595; G06F 17/30206; H04L 9/0637

(57) ABSTRACT

The present invention relates to identification and password technologies. More particularly, the invention relates to a method for producing a data structure for password identification employing a dynamic interface in combination with a virtual rolling code.

It provide a security method for user to machine communication In which a user can be defined as machine or other entity. The technology can used as security and method in applications such as blockchain, cryptocoins, peer to peer, Internet of things networks etc.

### FIELD OF THE INVENTION

The present invention relates to information technologies. More particularly, the invention relates to a method for producing a data structure for password identification in a machine to machine or user to machine configuration. In a preferred configuration the identification is a multilevel system consisting of a combination of at least 2 levels such as a user to machine communication and a machine to machine configuration.

### PRIOR ART

In today's modern economy, individuals typically establish accounts with different institutions and entities and use these accounts to interact with others to obtain goods and services and establish histories. Accounts are typically maintained on server computers under the control of the institution or entity. Such accounts, however, are often vulnerable to security risks such as hacking and identity theft and are frequently out-of-date or inconsistent.

It is conventionally known that the services and devices can require a password identification to allow access to the device and to the data stored within or accessible thereby. This password requirement is most commonly encountered on the devices, which occurs during the initial boot up of the software of the device. However, for added security, many individuals will also password protect select files, emails, and other desired information which should be confidential.

### SUMMARY

The present invention relates to identification and password technologies. More particularly, the invention relates to a method for producing a data structure for password identification employing a dynamic interface in combination with a virtual rolling code.

It provide a security method for user to machine communication In which a user can be defined as machine or other entity. The technology can used as security and method in applications such as blockchain, cryptocoins, peer to peer, Internet of things networks etc.

### DESCRIPTION OF THE INVENTION

The system, employing software running on a microprocessor such as a server, and communicating over a network, is configured to the task of providing each machine with a dynamically changing object, personal to that machine, and thereby indiscernible by third parties. Generation of the changing object is provided through following a set of pre-defined machine-criteria for generating a communicated data string representing a password, which is personal in input determination such that it can only be determined by the machine who set the original criteria.

The machine pre-defines the set of viewable objects and/or sounds, but not the position of the objects on the object nor the timing of the communication of sounds to their ears. The objects can be one or combination of objects, from a group of objects consisting of pictures, images, phrases, questions, numbers, colors, colored numbers, and/or sounds, and the like, which are embedded into the background of a display screen presented the machine as the objects, or communicated to the machine concurrently with the display screen as sounds.

In combination with the plurality of objects, or sounds, the machine additionally pre-defines a word-association with each respective object or sound communicated and discerned during a login. For example, an object may be a picture of the machine's childhood dog, and the associated word for input or matching with indicia on the screen, may be the dog's name “Spot”. Or, the object depicted on the login display may be a picture of an elderly woman, preferably the grandmother or another woman probably only known by the machine, which may be assigned the word “Granny” for input or matching to indicia on the screen. Or, for instance, a question may be chosen and presented the machine on login, and the answer is the associated word which is only known by the machine, and so on. Additionally, sounds such as the sound of the machine's mother's voice or that of another relative or friend which will easily be recognized by the machine on broadcast of the sound, thereby allowing the machine to input a matching word, or object.

With the plurality of objects and/or sounds which are chosen by and therefor easily remembered by the user or machine, when a password or security input is required for access to a device or system, the object is communicated and displayed to the machine displaying a sequence of the objects, a grid (i.e. X-Y grid), or a matrix with the objects randomly positioned at various locations of the depicted object, or along with one or a plurality of sounds which may play upon input to play such, or as an identifier by oral object for the machine to identify. Thus, pictures, photos, and sounds, displayable to the machine and personal only to each machine, are placed into a database for communication to the machine on screen or by auditory means, in subsequent logins.

Prior to such subsequent logins, the machine may also pre-define the sequence or pattern criteria for their subsequent selecting of the objects positioned on the object or sounds communicated during display of the object, and a subsequent inputting of text associated with each, or a subsequent matching of objects or sounds to displayed icons, photos, drawings, or text, which when read or seen by the machine, matches.

By employing this pattern, and a means for visually determining the objects or determining sounds through auditory means, a number of which may sequentially correspond to the machine—known pattern displayed on the object, an authentication password string or pattern is determined. The password or authorization string is determined by the machine typing the corresponding dynamic word string defined by the machine's pre-defined words which are associated with the viewed objects in that particular sequence. Or by a drag and drop method of matching displayed objects to displayed text or a matching of displayed objects with predetermined secondary objects, or by a matching of an icon or displayed object associated with a played sound, to a displayed object or word. For instance a sound is playable by a machine selecting the phonograph icon, that sound being their mother's voice. Thereafter the machine would drag the icon associated with the sound that played to a communication with an object being a photo or rendition of their mother.

Software adapted to the task, monitoring machine inputs, would discern this drag and drop, and using randomly associated numbers or codes preassigned that day, to each of the sound icon and the mother's picture, would generate an authentication string, and communicate it to the device, or over the network for network access. Software adapted to the task of matching the authentication string, to one or more strings based on the randomly assigned strings to each sound and object communicated that day, and temporarily stored in memory, will ascertain if a proper password string is communicated by the machine's actions in identifying the objects and/or sounds using textual or graphic matching inputs or combinations thereof.

As a simple example, the object may be a simple sequence of three objects positioned in a row. The machine first defines their preferred code criteria. For the code criteria, the machine selects a plurality such as three images well known to the machine and assigns word associations for each which they can easily remember. The machine causes matching words, or graphic associations, to be associated with the images or objects or sounds, to be stored in a relational database.

Now, using the associated words for each object or image displayed or sound transmitted and heard, known only to the machine, the password will always be defined by the dynamic word string consisting of a sequential string of those associated words from the group of associated words and objects in the database. The input words for each respective displayed objects will be typed using the machine—associated words sequentially using the known and pre-determined pattern of selection. Alternatively, icons or objects, having text or graphics discernable by the machine, and matching the text or words the machine defines to identify the objects are displayed. The machine will drag and drop, to mate the objects with the icons or objects matching them and known to the machine to input the string.

Again, in this example the authentication pattern is POSITION-2, POSITION-1, and POSITION-3. Therefor, the password is the word string constructed from the words associated from the images in the above positional pattern, in this case IMAGE-1, IMAGE-3, and IMAGE-2. Therefor the word string for this password is “momspotvacation”. The associated words are easily remembered by the machine since the objects are photos or pictures of a very dear person, a fondly remembered place, and a pet. The machine inputs this string into the password input window in the correct sequence, and authentication is verified by software adapted to compare the input words in the input sequence to the stored images and objects in the relational database. Since the sequence is known to the machine and the words easily remembered, a correct string of words is generated and the machine is allowed access.

Upon ending the authenticated session (i.e. logging out, turning off the device, etc.) the system employing software adapted to the task, then forgets the previously input password, and upon another authentication attempt (i.e. logging back in) the objects or images depicted in the object presented to the machine may either be different from a group larger than the number of image spots, or at least displayed in a different order.

Using the predetermined sequence for input and the objects or images placed in the three positions, software adapted to the task will then determine a correct new password based on the newly ordered objects or images positioned in the object. Thereafter, employing the same known sequence for the authentication pattern, the machine can easily determine the correct word string for input of a totally different password.

In an alternative but especially preferred mode of the system, the known objects and known sounds along with other sounds and objects, are communicated to the machine device for display and sound, from a server storing such for the system as originally provided by machine choice and identification.

In the communication upon initiation of a login by the machine, with each object, picture, sound, or other indicia or displayed material communicated by the server to the machine device, a random code or string is also associated. The association and random strings are also temporarily stored in memory on the server or machine. When the machine, during login, makes the appropriate match of object and sound to machine pre-identified indicia or matching object or other matching input in the object, the random strings of code or text communicated as associated with the objects and sounds, are combined and re-communicated back to the server. The random matched strings of text or code are compared to the temporary stored matched strings in memory, and if correct, access is provided. In this mode, the strings of code or text which are communicated are always random, and never the same on a subsequent visit. Thus, a hacker or third party monitoring the machine input or communications across the network, will never be able to capture reusable strings and string matches, since on every subsequent visit, new strings of code or text are associated with each object and sound communicated to the object login of the machine, and any prior captured login information will be useless.

This mode of the system, using randomly assigned code, text, or other transmittable identifiers, is especially preferred since there is no actual machine input of text or code required, just a matching of symbols or objects or icons or such on their object to the pictures or sounds or depictions of people or memories only known to the machine is required to communicated matching random code or text or other identifiers associated with the machine matches.

Continuing the example for a machine in the above second instance, in this second instance the depicted objects or images positioned in the sequence in the object may now show the machine; at POSITION-1 is shown IMAGE-2, at POSITION-2 is shown IMAGE-3, and at POSITION-3 is shown IMAGE-1. Therefore, the password set by the system, and determined by the machine using the known authentication pattern or sequence, will be “spotvacationmom,” or in the case of randomly assigned identifiers for the pattern matching a string of random text, or numbers, or other transmittable identifiers will be communicated and compared to a temporarily stored version of the same to ascertain match.

Again, in all modes, the images or objects or sounds or other displayable or broadcastable objects or sounds communicated to the object of the machine, are known well to the machine. However, for most third parties, such would be unknown, and even to friends and family of the party who has programmed the database, some of the objects or sounds can be such they would be unable to easily discern a proper match either.

One skilled in the art will realize that the complexity of the system and therefor difficulty for a hacker to determine the password can be increased by many factors. First, the total number of objects stored in group for a machine in the relational database can be increased. Since the objects are preferably images of people or things well known to the machine, the number of images or objects can be very large, and each associated to the word to that respective image causes the machine to easily remember. This word association provides an advantage over prior art as it is solely known to the machine and preferably uses images or objects which are easily remembered by the machine but would be virtually unknown to strangers.

Additionally, the object may present a longer sequence of objects, or sounds, or a grid of objects, or a matrix of objects and/or interlaced sounds, and/or some changing in the sequence used for input for the grid or matrix. All can either have the machine input identifiers and communicated strings of text or code or may be matched with randomly generated strings by the software adapted to the task, as noted above. As such the authentication pattern can be one of an infinite number of patterns using an extremely large number of objects chosen specifically by the machine. Further, the authentication pattern itself can be selectively changed by the machine with each authentication process, or by the system using randomly assigned identifiers or strings or code to sounds and objects to be matched, which can still provide the machine an easily discerned clue on proper matches to be communicated from the object as to the required sequence for each session input.

Therefore, the method herein provides a machine with a dynamic rendering of objects or pictures or sounds in an object and sound reproduction devices engaged therewith, which may be viewed, heard, and remembered, and associated with a word or other communicable identifier, for determining a proper machine input to function as a password identification based off machine—determined and easily remembered memories and personal criteria. The system, when communicating across a network, in addition to assigning random identifiers to objects and sounds, may employ software adapted to the task of data encryption to further prevent hackers from obtaining information during the authentication process. However, even if some input data for a password at one session is discerned through electronic eavesdropping, since the input identifiers of the matching objects and sounds changes with each subsequent session, a stolen input from the machine on one occasion acting as a password from one session would be useless on a subsequent session.

With respect to the above description, before explaining at least one preferred embodiment of the herein disclosed invention in detail, it is to be understood that the invention is not limited in its application to the details of construction and to the arrangement of the components in the following description. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”.

Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of this invention to provide a security system for machine login which is personalized to the memories of the machine and therefor hard to forget for the machine and virtually impossible to discern for third parties.

This and other objects of the invention will be brought out in the following part of the specification, wherein detailed description is for the purpose of fully disclosing the invention without placing limitations thereon.

As in the above described technology the machine can be considered as the user. The user can be also considered a personal user, a group of users, artificial intelligence, a second machine, a network of machines, a computer device or a blockchain like network.

The user provide the input using an interface. As used in the claims to describe the interface indicates the following possible variations of interfaces:
Graphical User Interface (GUI): interface with a computer or machine using graphics, widgets or text. The input can be displayed by a dashboard, a screen or a projector.
Command-line-interface (CLI): interface with a computer or machine using a command line with one or more text lines. The input can be provided by a keyboard, a microphone, a dashboard, a computer mouse, touchscreen or artificial intelligence.
Character-based user interface (CBUI): interface with a computer or machine using a representation of data using characters. The input can be provided by a keyboard, a microphone, a dashboard, a computer mouse, touchscreen or artificial intelligence.
Text user interface (TUI): interface with a computer or machine using a representation of data using text. The input can be provided by a keyboard, a microphone, a dashboard, a computer mouse, touchscreen or artificial intelligence.
a Brain-computer interface (BCI): interface with a computer or machine using a using a Neural Information Processing (NIP) device that enables communication between a machine and the human brain.
Image recognition interface (IRI): interface with a computer or machine using a device that enables communication between a machine and user using images, movement, gestures, machine or hardware DNA.
The images can be a print of DNA, fingerprint, iris scan
Intelligent user interface (IUI): interface with a computer or machine using artificial intelligence that enables communication between a machine and user. A additional possibility is that the interface with a computer or machine is the use of formulas, algorithm, mathematical figures or other logic sequences to enable communication between a machine and user.
Hardware interface design (HID): interface elements include touchscreens, knobs, buttons, sliders and switches as well as input sensors such as microphones, cameras, and accelerometers.
Voice-user interface (VUI): an interface that makes human interaction with computers possible through a voice/speech platform in order to initiate an automated service or process.

The above described technology can used to access blockchain-based identity and transaction platforms but can also be a part of the identity displaced on the blockchain. In an example approach, identity information (e.g., a photo) for a person can be encrypted and stored in a blockchain as part of enrolling the person as a user in a blockchain-based identity and transaction platform. Trust relationships using the above described technology can be formed between the user and other users, and records of the trust relationships can be stored in the blockchain.

Transactions between the user and other users with whom the user has formed a trust relationship can be authorized. Records of the transactions can also be stored in the blockchain. Authorization a described as above can involve, for example, a verification process that accesses information stored on the blockchain. The transactions and identity information, along with other information, can contribute to an economic identity of the person. Storing an economic identity (and the underlying information that forms the economic identity of the person) in the blockchain results in a secure platform accessible to people regardless of their economic or geographic circumstances.

The above described technology is used to the authorization of a blockchain-based transaction, specifically the use of payment network transaction messages and payment networks to securely store and convey transaction details for a blockchain-based transaction for use thereof in execution of the blockchain-based transaction.

The above described technology is used to store and protect identity data on a wallet. In an example embodiment, a server computer system is communicatively coupled to one or more client computers and to a distributed blockchain computer system that includes multiple computing nodes, each computing node storing a copy, or a portion thereof, of a blockchain of the distributed blockchain computer system. The server computer system is configured to: record on the blockchain, by transmitting one or more electronic messages to the distributed blockchain computer system, ownership information of respective groups of one or more units of an asset for each of a plurality of owners of the asset; and to configure, for each of one or more of the plurality of owners, a digital wallet corresponding to one of said groups of one or more units of the asset, the digital wallet being associated with a private cryptographic key using the above described technology and at least one blockchain address generated based upon the private cryptographic key.

The above described technology can be used to access control using a blockchain data structure.

Computing resources such as hardware, software or combination resources are increasingly deployed in a distributed manner. Resources can include, for example: security services such as antimalware, proxy, antivirus, scanning or protective services; data storage services such as real or virtualised memories, data stores or databases; middleware services such as messaging middleware software, transaction handling software and the like; business process automation such as commercial applications, bespoke business process software and the like; network services such as telecommunications, communication facilities, internet servers or websites; directory services such as registries; media services such as audio, video or multimedia; network access facilities; entertainment services such as computer entertainment software, video games and the like; social media services; and other resources or services as will be apparent to those skilled in the art. Distributed computing environments are environments in which computer systems, services and supporting or offered resources (whether hardware, software or a combination) are distributed physically and/or virtually with a dependence on communications networks for interoperability.

The above described technology can be defined for the use of a proprietary private blockchain, specifically the submitting of data captured in a transaction message to a blockchain for clearing and settlement for the transaction using a private blockchain as an alternative to traditional transaction settlement.

The above described technology as base for a tokenisation System for Blockchain-based Cryptocurrencies Technical Field to provide a solution for the control and/or transfer of an asset, or the transfer of ownership of an asset. In particular, it relates to a method of creating, transferring ownership and redeeming tokens which represent assets. The present disclosure has particular application with creating tokens associated with transactions on a peer-to-peer distributed ledger such as, for example, the Bitcoin blockchain The token may be representative of a contractual right, smart contract or other form of asset.

The above described technology can be used as an proper authentication input or password to computer networks, and, more particularly, to block chain-based device identity verification and anomaly detection in Internet of Things (IoT) and similar networks. The possibility to use rolling codes in different cross over authorization methods can make IoT more secure and expand his possibilities.

What is claimed:

1. A method for generating a changing authentication input or password required for a first machine accessing another machine such as a smartphone, a robot, a server or network of servers over a network, where said computing device is in an operative machine to machine interface (MMI) using running software adapted for operation and the steps of:
having a first machine employ said input component to associate a relating object, associated to each respective recognizable object;
electronically storing each respective said relating object, in a respective association with each respective said recognizable object, in a relational database;
upon an access attempt to the connected machine, communicating with an device presenting at least one said recognizable object in a group of depicted objects;
allowing said first machine to input a communication confirming a discerning of a said recognizable object, from said group of depicted objects;
communicating to said first machine depicting at least one group of relatable objects having a said relating object therein associated to said recognizable object;
allowing said first machine to communicate a discerned said relating object, from said group of relatable objects;
generating a comparative authentication string from said recognizable object and said discerned said relating object communicated by said first machine; and
authenticating said first machine if said comparative authentication string is determined by said software to have a match between said recognizable object and said relating object associated to said recognizable object by said first machine.

2. The method of claim 1 wherein said first machine is using artificial intelligence to communicate with a machine such as a smartphone, a robot, a server or network of servers.

3. A method for generating a changing authentication input or password required for a user accessing a machine such as a smartphone, computer device, server, a network of servers, robots or machines in general, where said machine is in operative communication with an user interface (UI) and running software adapted for operation and the steps of:
having said user employ said input component to associate an input string with each respective said object in a group of said objects; electronically storing each respective said input string associated with each respective said object in said group of said objects, in a relational database;
upon access attempts to said computing device, displaying a plurality of said objects from said group of said objects with each respective object in a respective individual position upon said UI to form a sequence of said objects displayed on said UI;
having said user ascertain said sequence for an input of each respective said input string associated by said user with each respective said object in said plurality;
providing an input area in said UI for said user to input an authentication string formed by employing said input device to input in said sequence, each respective said input string associated with each respective said object in said plurality of individual positions;
generating a comparative authentication string by assembling in said sequence, each of said input strings stored in said relational database which are associated with a respective one of said plurality of objects displayed in said plurality of individual positions; and
authenticating said user if said comparative authentication string is determined by said software to match said authentication string input by said user.

4. The method of claim 3 wherein said UI could be a Human Machine Interface (HMI) such as a Graphical User Interface (GUI), a command-line-interface (CLI), a character-based user interface (CBUI), a text user interface (TUI), a Brain-computer interface (BCI), an image recognition interface (IRI), an Intelligent user interface (IUI), a Hardware interface design (HID), a Voice-user interface (VUI) or a combination of a least 2 of the previous said interfaces.

5. The method of claim 1-2 wherein said user in not required to identify said recognizable object in said communication confirming a said discerning of said recognizable object.

6. The method of claim 1-2 additionally comprising the steps of:
having said first machine or user employ said input component to associate a plurality of said relating objects, all of said plurality relating to one respective said recognizable object;
communicating to said first machine or user a plurality of said objects in a sequence, each depicting a said group of relatable objects having a said relating object therein which is associated with said recognizable object;
allowing said first machine or user to communicate a discerned said relating object, from each said group in a plurality of said groups of said relatable objects communicated in said plurality of depicted objects;
generating said comparative authentication string from said recognizable object and said discerned said relating objects communicated by said first machine or user from said plurality of groups of relatable objects; and authenticating said first machine or user if said comparative authentication string is determined by said software to have a match between said recognizable object, and said relating objects associated to said recognizable object by said first machine or user.

7. The method of claim 5 additionally comprising the steps of:
having said first machine or user employ said input component to associate a plurality of said relating objects, all of said plurality relating to one respective said recognizable object;
communicating to said first machine or user a plurality of said objects sequentially, each depicting a said group of relatable objects having a said relating object therein which is associated with said recognizable object;
allowing said first machine or user to communicate a discerned said relating object, from each said group in a plurality of said groups of said relatable objects communicated in said plurality of depicted objects;
generating said comparative authentication string from said recognizable object and said discerned said relating objects communicated by said first machine or user from said plurality of groups of relatable objects; and
authenticating said first machine or user if said comparative authentication string is determined by said software to have a match between said recognizable object, and said relating objects associated to said recognizable object by said first machine or user.

8. The method for generating a changing proper authentication input or password of claim 6-7 additionally comprising the steps of:
changing said sequence of said plurality of objects, for each successive said access attempt.

9. The method for generating a changing proper authentication input or password of claim 1-4 additionally comprising the steps of:
allowing said first machine or user to provide some or all of said recognizable objects in said group of said recognizable objects, using graphically displayable renderings associated with familiar objects comprised of people, places, things, or sounds, known to said first machine or user, and
employing said familiar objects as said recognizable object, thereby providing said first machine or user a means for easy recognition of said recognizable object.

10. The method for generating a changing proper authentication input or password of claim 8 additionally comprising the steps of:
allowing said first machine or user to provide some or all of said recognizable objects in said group of said recognizable objects, using graphically displayable renderings associated with familiar objects comprised of people, places, things, or sounds, known to said first machine or user, and
employing said familiar objects as said recognizable object, thereby providing said first machine or user a means for easy recognition of said recognizable object.

11. The method for generating a changing proper authentication input or password of claim 1-4, additionally comprising the steps of:
including one or a plurality of questions in said group of recognizable objects; and
electronically storing a respective answer to each respective said question included in said group of recognizable objects as relatable object associated with each respective said recognizable object in said relational database.

12. A method for generating a changing proper authentication input or password of claim 5, additionally comprising the steps of:
including one or a plurality of questions in said group of recognizable objects; and
electronically storing a respective answer to each respective said question included in said group of recognizable objects as relatable object associated with each respective said recognizable object in said relational database.

13. The method for generating a changing proper authentication input or password of claim 10, additionally comprising the steps of:
including one or a plurality of questions in said group of recognizable objects; and
electronically storing a respective answer to each respective said question included in said group of recognizable objects as relatable object associated with each respective said recognizable object in said relational database.

14. A method for generating a changing authentication input or password required for a first machine accessing another machine such as a smartphone, a robot, a server or network of servers over a network, where said computing device is in an operative machine to machine interface (MMI) using running software adapted for operation and the steps of:
having said first machine employ said input component to associate an input string relating to each respective recognized object in a group of said recognized objects;
electronically storing each respective said input string in a respective association with each respective said recognized object in said group of said objects, in a relational database;
upon access attempts to said computing device, communicating with an device presenting a plurality of said recognized objects from said group of said recognized objects with each respective recognized object in a respective individual position upon said machine, to form a sequence of said recognized objects displayed on said machine;
having said first machine ascertain said sequence, for an input of each respective said input string associated by said first machine with each respective said recognized object in said plurality;
providing an input area in said machine for said first machine to input an authentication string formed by employing said input device to input in said sequence, each respective said input string associated with each respective said recognized object in said plurality of individual positions chosen by said first machine for said input;
generating a comparative authentication string by assembling in said sequence, each of said input strings stored in said relational database which are associated with a respective one of said plurality of recognized objects displayed in said plurality of individual positions; and
authenticating said first machine if said comparative authentication string is determined by said software to match said authentication string input by said first machine.
generating a comparative authentication string by assembling in said sequence, each of said input strings stored in said relational database which are associated with a respective one of said plurality of recognized objects displayed in said plurality of individual positions; and
authenticating said first machine if said comparative authentication string is determined by said software to match said authentication string input by said first machine.

15. A method for generating a changing authentication input or password required for a user accessing a machine such as a smartphone, computer device, server, a network of servers, robots or machines in general, where said machine is in operative communication with an user interface (UI) and running software adapted for operation and the steps of:
having said user employ said input component to associate an input string relating to each respective recognized object in a group of said recognized objects;
electronically storing each respective said input string in a respective association with each respective said recognized object in said group of said objects, in a relational database;
upon access attempts to said computing device, communicating a said UI displaying a plurality of said recognized objects from said group of said recognized objects with each respective recognized object in a respective individual position upon said UI, to form a sequence of said recognized objects displayed on said UI;
having said user ascertain said sequence, for an input of each respective said input string associated by said user with each respective said recognized object in said plurality;
providing an input area in said UI for said user to input an authentication string formed by employing said input device to input in said sequence, each respective said input string associated with each respective said recognized object in said plurality of individual positions chosen by said user for said input;
generating a comparative authentication string by assembling in said sequence, each of said input strings stored in said relational database which are associated with a respective one of said plurality of recognized objects displayed in said plurality of individual positions; and
authenticating said user if said comparative authentication string is determined by said software to match said authentication string input by said user.

16. A method for generating a changing proper authentication input or password a described in claim 1-15, to enter a network using a Blockchain like structure

17. A method for generating a changing proper authentication input or password as described in claim 1-16 in which the identification code is at least partly integrated in the string of the crypto code within a Blockchain like structure.

18. A method for generating a changing proper authentication input or password a described in claim 1-15 for securing access to wallets in which crypto currencies and/or their secrets are stored.

19. A method to enter a Blockchain like network using at least the combination of the authentication input or password as described in claim 1 and claim 3. This combination can be extended with one or more additions as described in claim 2 and claims 4-18

20. A method for generating a changing proper authentication input or password a described in claim 1-19 in which the digital combinations are hash functions.

21. A method for generating a changing proper authentication input or password a described in claim 1-20 in which the identifier is provided from a hardware security key device.

22. A method for generating a changing proper authentication input or password a described in claim 1-21 is used for authorizing a blockchain-based transaction.

23. A data record structure adapted for generating a changing proper authentication input or password a described in claim 1-21 for transmission over a network; the data record generated on a network device participating in a Blockchain as an initiating device which has an initiating device unique identifier; the data record structure containing at least a first record and a first unique identifier record; the first record containing data for transmission over the network to a device having a receiving device unique identifier; the first unique identifier record containing the initiating device unique identifier.

24. The data record of claim 23 wherein data from or pertaining to the first record is contained in a ledger or wallet

25. A method for generating a changing proper authentication input or password a described in claim 1-22 is used for defining a cryptocurrency for indicating authorization to access the resource, the cryptocurrency being formed of tradeable units of value associated with records in the blockchain and wherein transfer of the cryptocurrency between records in the blockchain.

26. A method for generating a changing proper authentication input or password a described in claim 1-22 is used to access the resource, the cryptocurrency being formed of tradeable units of value associated with records in the blockchain and wherein transfer of the cryptocurrency between records in the blockchain.

27. A method for generating a changing proper authentication input or password a described in claim 1-26 comprising the steps of:
generating a blockchain transaction (Tx) having an output (TxO) related to a digital asset and a hash of a redeem script which comprises:
metadata comprising a token which is a representation of, or a reference to, a tokenised entity;
and at least one public cryptographic key.

28. A computer-implemented method of determining the validity of a token associated with a quantity of cryptocurrency, the method comprising:
receiving, over a communications network, a first transaction comprising a transfer of the token from a first user or machine to a second user or machine; querying a peer-to-peer distributed ledger to determine whether an authenticated transaction associated with the token can be identified, wherein the authenticated transaction comprises a previous transaction associated with the token and wherein the token has been authorized according methods as described in claim 1-26; and
responsive to identifying an authenticated transaction, determining that the token is valid.

29. A method for generating a changing proper authentication input or password a described in claim 1-28 as a trust mechanisms for a peer-to-peer network computing platform.

30. A method for generating a changing proper authentication input or password a described in claim 1-29 as a trust mechanisms for IoT network computing platform.

31. A method for generating a changing proper authentication input or password a described in claim 30 in which the technology is using in a crossover configuration.
